(19) United States
(12) Patent Application Publication
(10) Pub. No.: US 2020/0152115 A1
(43) Pub. Date: May 14, 2020

(54) Source driver and related selector

(71) Applicant: NOVATEK Microelectronics Corp., Hsin-Chu (TW)

(72) Inventors: Chao-Kai Tu, Hsinchu City (TW); Yueh-Hsun Tsai, Taipei City (TW); Tzung-Yun Tsai, Hsinchu County (TW); Kai-Yue Lin, Hsinchu City (TW); Ying-Hsiang Wang, New Taipei City (TW)

(21) Appl. No.: 16/183,746

(22) Filed: Nov. 8, 2018

(51) Int. Cl. G09G 3/20

(52) U.S. Cl. CPC G09G 3/2092; G09G 2310/0297; G09G 2310/0291; G09G 2310/027; G09G 2330/023; G09G 2310/0254; G09G 2310/0289; G09G 2330/028

(57) ABSTRACT

A source driver for a panel includes a plurality of driver cells. Each of the driver cells includes an output driver, a plurality of bias voltage generators and a selector. The output driver is configured to output a plurality of display data to the panel. The plurality of bias voltage generators is coupled to the output driver. Each of the bias voltage generators is configured to provide at least one bias voltage for the output driver. The selector, coupled to the output driver, is configured to select the bias voltage from one of the bias voltage generators to be provided for the output driver according to the plurality of display data.

### BACKGROUND OF THE INVENTION

### 1. Field of the Invention

The present invention relates to a source driver and a related selector, and more particularly, to a source driver and selector capable of providing adaptive bias selection and frequency response compensation.

### 2. Description of the Prior Art

A source driver is a driver circuit for controlling the operations of a display panel such as a liquid crystal display (LCD) or an organic light-emitting diode (OLED) panel. The source driver provides display data for the display panel, to control each pixel or subpixel of the display panel to show target brightness, so as to construct the entire image. The source driver may include multiple channels, each configured to provide display data for a column of subpixels in the display panel. An operational amplifier is usually disposed at the output terminal of each channel, for driving the corresponding data line on the panel to reach its target voltage.

However, in a general display panel, each column of subpixels may include hundreds or thousands of subpixels, which generate a great amount of parasitic capacitance on the data line, such that the operational amplifier is required to have a driving capability which is higher enough to drive the data line. In the operational amplifier, the higher driving capability is accompanied by larger current and power consumption. In a conventional source driver, the operational amplifier in each channel applies an identical bias voltage configuration to achieve identical current consumption and driving capability. The total power consumption is quite large since there may be a larger number of channels in the source driver. In order to reduce the power consumption, the current and driving capability should be reduced. Also, reduction of the current may lead to less phase margin, which results in poor stability of the operational amplifier.

Thus, there is a need to provide a novel source driver having operational amplifiers consuming lower power while the stability is maintained at a satisfactory level.

### SUMMARY OF THE INVENTION

It is therefore an objective of the present invention to provide a source driver having a selector capable of selecting bias voltages for an output driver based on the input display data.

An embodiment of the present invention discloses a source driver for a panel. The source driver comprises a plurality of driver cells, and each of the driver cells comprises an output driver, a plurality of bias voltage generators and a selector. The output driver is configured to output a plurality of display data to the panel. The plurality of bias voltage generators is coupled to the output driver. Each of the bias voltage generators is configured to provide at least one bias voltage for the output driver. The selector, coupled to the output driver, is configured to select the bias voltage from one of the bias voltage generators to be provided for the output driver according to the plurality of display data.

Another embodiment of the present invention discloses a selector fora source driver, for controlling at least one bias voltage provided for an output driver of the source driver. The selector comprises a controller and a multiplexer. The controller is configured to receive a first display data and a second display data of the source driver, and generate a control signal according to a difference between the first display data and the second display data. The multiplexer, coupled to the controller, is configured to select one of a plurality of bias voltage generators to be coupled to the output driver according to the control signal from the controller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a general source driver.

FIG. 2 is a schematic diagram of a source driver according to an embodiment of the present invention.

FIG. 3 is a schematic diagram of a detailed implementation of the source driver shown in FIG. 2.

FIG. 4 is a schematic diagram of an exemplary operation of the selector.

FIGS. 5A to 5C are schematic diagrams of relations between the difference value of the received display data and the control signal.

FIG. 6A is a schematic diagram of an exemplary structure of an output driver according to an embodiment of the present invention.

FIG. 6B illustrates a Bode plot corresponding to the output driver shown in FIG. 6A.

FIG. 7A is a schematic diagram of the output driver controlled by a selector.

FIG. 7B illustrates a Bode plot corresponding to the output driver with the compensation capacitors.

FIG. 7C illustrates a Bode plot corresponding to the output driver with the output resistors.

FIG. 8 is a schematic diagram of a source driver with cooperation of two adjacent channels so as to achieve polarity inversion.

FIG. 9 is a waveform diagram of the switching signals.

FIG. 10 is a waveform diagram of the switching signals with different open time length of the output switches.

FIGS. 11A and 11B are waveform diagrams of the output data of the output driver in different operation modes.

FIGS. 12A and 12B are waveform diagrams of the switching signals and corresponding statuses of a capacitor switch and a resistor switch.

### DETAILED DESCRIPTION

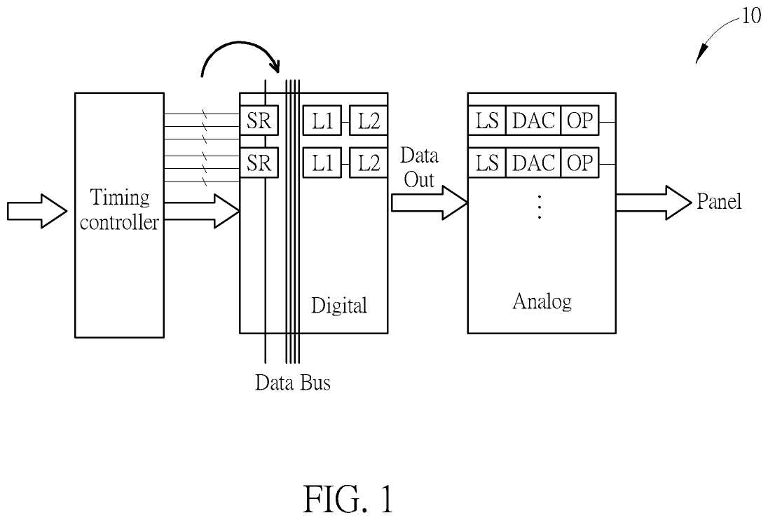

Please refer to FIG. 1, which is a schematic diagram of a general source driver 10. As shown in FIG. 1, the source 10 includes a plurality of channels, each including a shift register (SR), two latches L1 and L2, a level shifter (LS), a digital to analog converter (DAC) and an operational amplifier (OP). The source driver 10 may be separated into a digital part and an analog part. The shift register and the latches are included in the digital part. The shift register is configured to control the operations of the latches L1 and L2 according to a timing sequence received from the timing controller. The latches L1 and L2 are configured to store the display data transmitted from a data source via data buses and deliver the display data according to the control of the shift register. In an implementation, a row of display data are transmitted to the latch L1 of each channel by turns, and then forwarded to the latch L2 in parallel, allowing the row of display data to be forwarded to the display panel to update a row of image at the same time. The level shifter, the DAC and the operational amplifier are included in the analog part. The level shifter, coupled to the latch L2, is configured to shift the voltage level of the display data transmitted from the latch L2. The DAC, coupled to the level shifter, then converts the display data in the digital form into an analog form. The operational amplifier, coupled to the DAC, is configured as a voltage buffer for transmitting the display data to drive the data line on the display panel.

As mentioned above, in the source driver 10, the operational amplifier in each channel applies an identical bias voltage configuration and thus has similar current consumption. In general, a bias voltage generator is responsible for providing bias voltages for multiple operational amplifiers indifferent channels. Note that the operational amplifier is configured to drive the data line of the panel to reach a target voltage, which follows a formula described below:

$$Δ V = \frac{I \cdot T}{C} ;$$

wherein ΔV refers to the voltage variation on the data line between two adjacent data, C is the equivalent capacitance driven by the operational amplifier, T is the time of voltage variation, and I is the output driving current of the operational amplifier. The purpose of reducing power consumption may be achieved by reducing the current in the operational amplifier. With a predetermined display panel (having predetermined capacitance on the data line), the current reduction may be achieved based on the voltage variation on the data line. More specifically, when the difference between a present data and a subsequent data is smaller, the voltage variation on the data line may become smaller, such that less driving capability of the operational amplifier is enough to drive the data line; hence, the operational amplifier may operate in a low power mode having less current consumption. In an embodiment, the current consumption may further be controlled by bias voltages of the operational amplifier. Therefore, the adaptive bias control based on the difference between two adjacent display data is performed, in order to achieve the reduction of power consumption.

Different from the conventional source driver where the operational amplifiers in different channels receive identical bias voltages from the same bias voltage source, in a source driver of the present invention, the bias voltage configuration of each operational amplifier is controlled based on the difference between two adjacent display data, and should be controlled independently since each channel forwards different display data. In other words, the bias voltage control for the output driver of a channel is independent from the bias voltage control for the output driver of other channels.

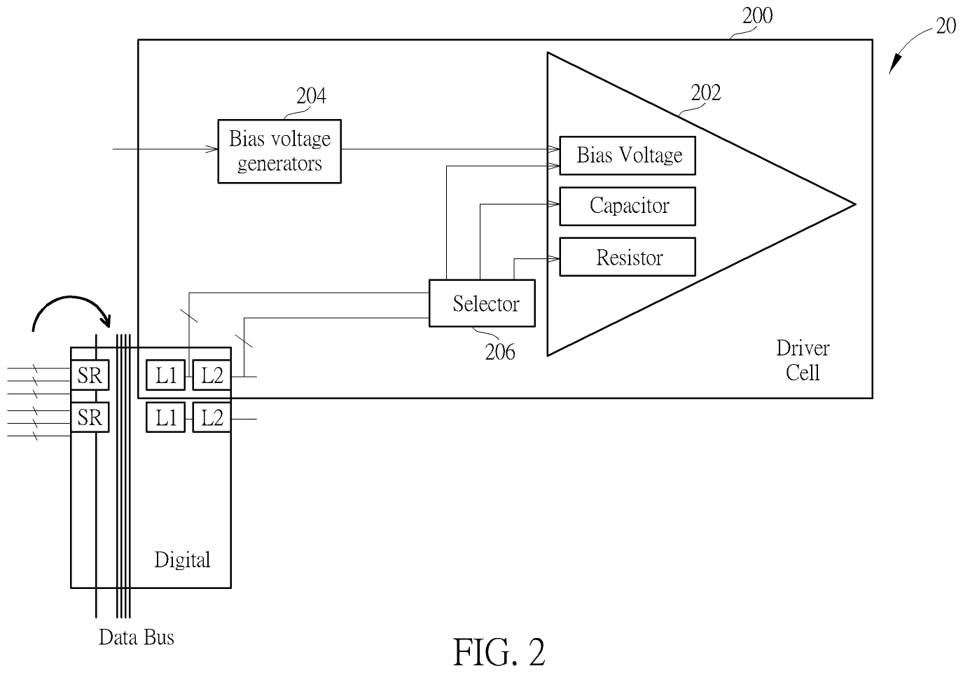

Please refer to FIG. 2, which is a schematic diagram of a source driver 20 according to an embodiment of the present invention. The source driver 20 includes a plurality of driver cells, each corresponding to a channel for outputting display data to a data line and a column of subpixels in a display panel coupled to and driven by the source driver 20. Each driver cell has a similar structure, and only one driver cell 200 is illustrated in FIG. 2 for brevity. The driver cell 200 includes an output driver 202, bias voltage generators 204, a selector 206, and two latches L1 and L2. The output driver 202 may be an operational amplifier, for outputting display data to the display panel. The bias voltage generators 204 are coupled to the output driver 202, and each of the bias voltage generators 204 may provide at least one bias voltage for the output driver 202. The selector 206, coupled to the output driver 202, is capable of controlling the bias voltage configuration of the output driver 202, so as to achieve power reduction. More specifically, the selector 206 may select the bias voltage(s) from one of the bias voltage generators to be provided for the output driver 202. In addition, reduction of the current in the output driver 202 may result in a lower phase margin and poor stability; hence, the selector 206 may further control the configurations of compensation capacitors and resistors for the output driver 202.

The selector 206 may select the bias voltage(s) from one of the bias voltage generators 204 according to the difference between two display data. For example, if the difference between a present data and a subsequent data is smaller, the selector 206 may select a set of bias voltage(s) which allows the output driver 202 to consume less power (and also have a lower driving capability). If the difference between a present data and a subsequent data is larger, the selector 206 may select a set of bias voltage(s) which allows the output driver 202 to have a higher driving capability (and also require more power). As a result, the adaptive selection scheme enjoys the benefits of lower power consumption, while the driving capability for driving larger voltage variation on the data line is not affected.

In an embodiment, the selector 206 performs selection based on the display data received from the latches L1 and L2. As mentioned above, the display data may be transmitted from the data source to the latch L1, and then forwarded to the latch L2. There is a time instant where a first display data is stored in the latch L1 and a second display data subsequent to the first display data is stored in the latch L2. Thus, the selector 206 may receive the first display data from the latch L1 and receive the second display data from the latch L2, and thereby select the bias voltage(s) according to the difference between the first display data and the second display data.

It should be noted that each channel has one driver cell similar to the driver cell 200 shown in FIG. 2. Therefore, each driver cell may perform the bias voltage control independently, so as to realize the optimal settings of the power consumption and driving capability of the output driver in each channel. In other words, each output driver may be independently configured with an optimal bias voltage setting based on the voltage variation to be driven (i.e., the data difference).

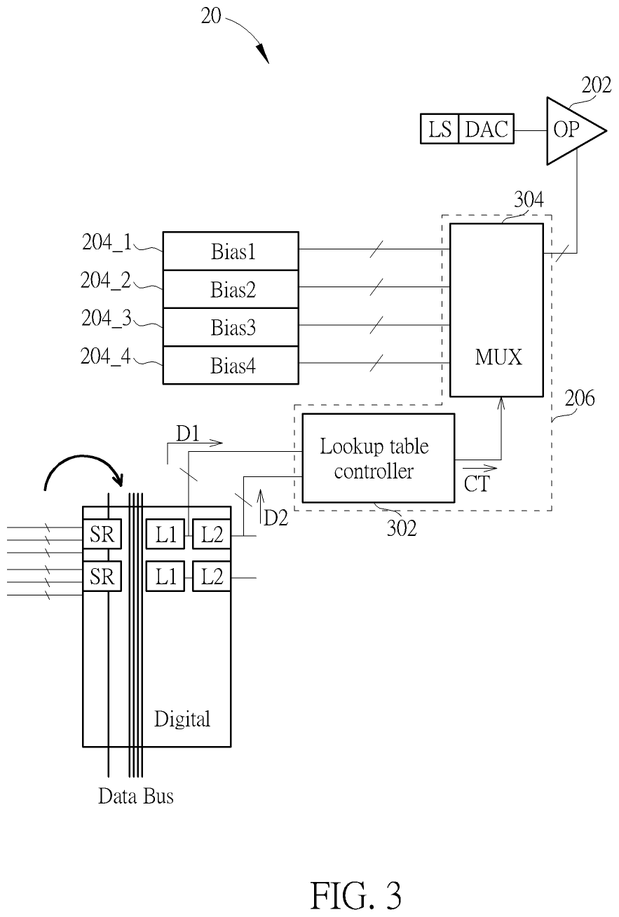

FIG. 3 illustrates a detailed implementation of the source driver 20. As shown in FIG. 3, there are 4 bias voltage generators 204_1-204_4 for providing different bias voltages for the output driver 202, where the different bias voltages may lead to different driving capabilities accompanied by different power consumption. The selector 206 includes a lookup table controller 302 and a multiplexer (MUX) 304. The lookup table controller 302 may receive the display data D1 from the latch L1 and receive the display data D2 from the latch L2, and thereby generate a control signal CT according to the difference between the display data D1 and D2. The MUX 304 may select one of the bias voltage generators 204_1-204_4 according to the control signal CT from the lookup table controller 302.

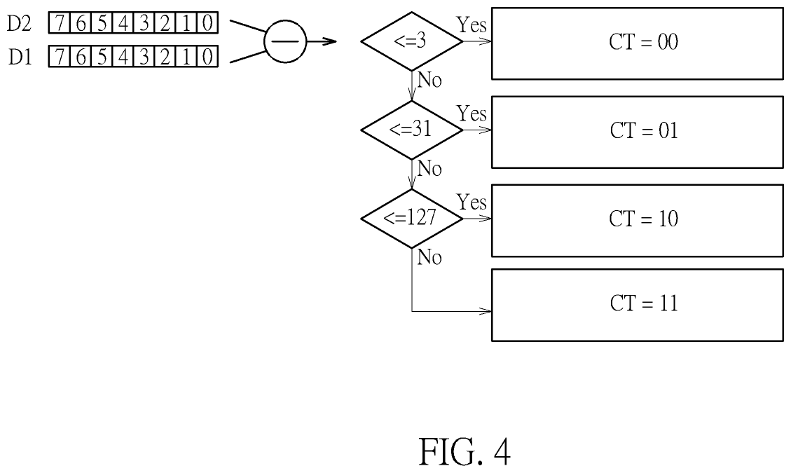

FIG. 4 illustrates an exemplary operation of the selector 206. In this embodiment, each display data D1 or D2 includes 8 bits (bit 0 to bit 7), which correspond to data values from 0 to 255. The bias voltage generators 204_1-204_4 output 4 sets of bias voltages having different levels of driving capability, respectively. More specifically, the bias voltage generator 204_1 outputs the bias voltages having the lowest driving capability, the bias voltage generator 204_2 is the second, the bias voltage generator 204_3 is the third, and the bias voltage generator 204_4 outputs those having the highest driving capability. The control signal CT may be a 2-bit bias select signal, and the values of the control signal CT, “00”, “01”, “10” and “11”, respectively indicate that the bias voltage generator 204_1, the bias voltage generator 204_2, the bias voltage generator 204_3 and the bias voltage generator 204_4 are selected.

As shown in FIG. 4, the lookup table controller 302 receives the display data D1 and D2, and compares the display data D1 and D2 to determine the difference between the values of the display data D1 and D2. The lookup table controller 302 first determines whether the difference value is equal to or smaller than 3, and outputs the control signal CT as “00” to select the bias voltages from the bias voltage generator 204_1 if the difference value is equal to or smaller than 3, where the bias voltages control the output driver 202 to operate in a low power mode. Otherwise, the lookup table controller 302 then determines whether the difference value is equal to or smaller than 31, and outputs the control signal CT as “01” to select the bias voltages from the bias voltage generator 204_2 if the difference value is equal to or smaller than 31. Otherwise, the lookup table controller 302 then determines whether the difference value is equal to or smaller than 127, and outputs the control signal CT as “10” to select the bias voltages from the bias voltage generator 204_3 if the difference value is equal to or smaller than 127. Otherwise, if the difference value is greater than 127, the lookup table controller 302 will output the control signal CT as “11” to select the bias voltages from the bias voltage generator 204_4, where the bias voltages control the output driver 202 to operate with full driving capability and higher power consumption.

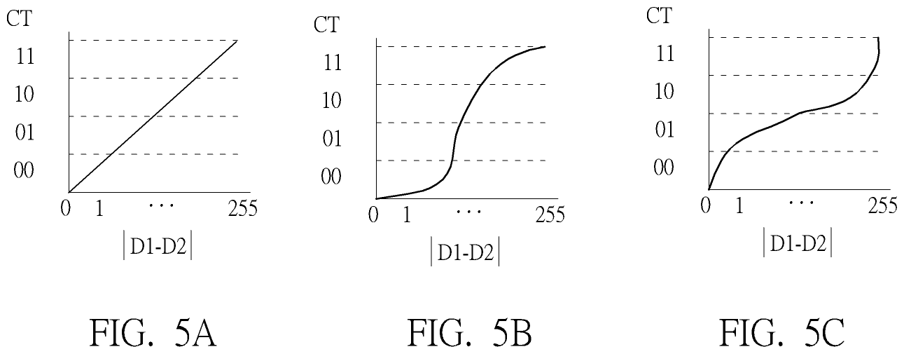

In an embodiment, the criteria of selecting the bias voltage generator may be implemented with a lookup table, so that the lookup table controller 302 may output the control signal CT that controls the MUX 304 to forward the bias voltages from a selected bias voltage generator based on the received display data D1 and D2 and/or their difference value recorded in the lookup table. The relations between the difference value of the received display data D1 and D2 and the control signal CT may be realized as a linear straight line shown in FIG. 5A, or a nonlinear curve shown in FIG. 5B or FIG. 5C. The details of the selection criteria should not be a limitation of the scope of the present invention.

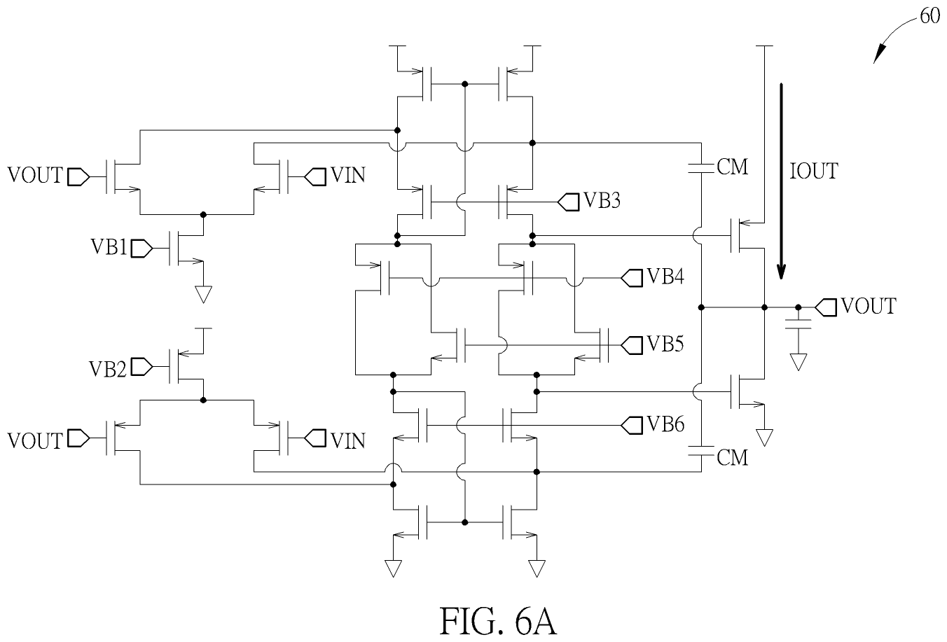

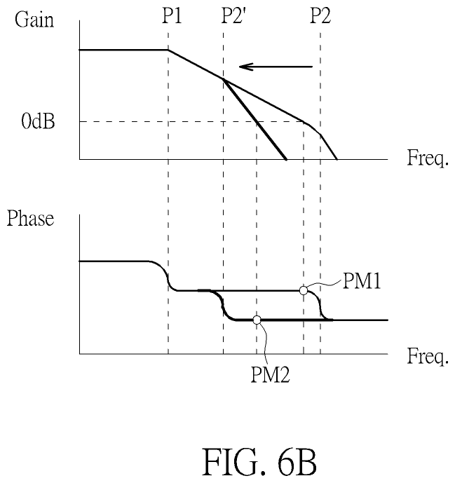

Please note that reduction of the output driving current may result in a lower phase margin and poor stability. Please refer to FIG. 6A, which is a schematic diagram of an exemplary structure of an output driver 60 according to an embodiment of the present invention. The output driver 60 is implemented as an operational amplifier with negative feedback connection to form a buffer, where the output driver 60 receives an input display data VIN to output an output display data VOUT. The output driver 60 further receives bias voltages VB1-VB6 to operate normally, and compensation capacitors CM are coupled between the output terminal and the gain stage to improve the stability. FIG. 6B illustrates a Bode plot corresponding to the output driver 60. As shown in FIG. 6B, the dominant pole P1 is mainly determined by the compensation capacitors CM, and the secondary pole P2 is influenced by the driving current IOUT. If the driving current IOUT is decreased, the secondary pole P2 will move to P2′, which results in reduced phase margin (from PM1 to PM2).

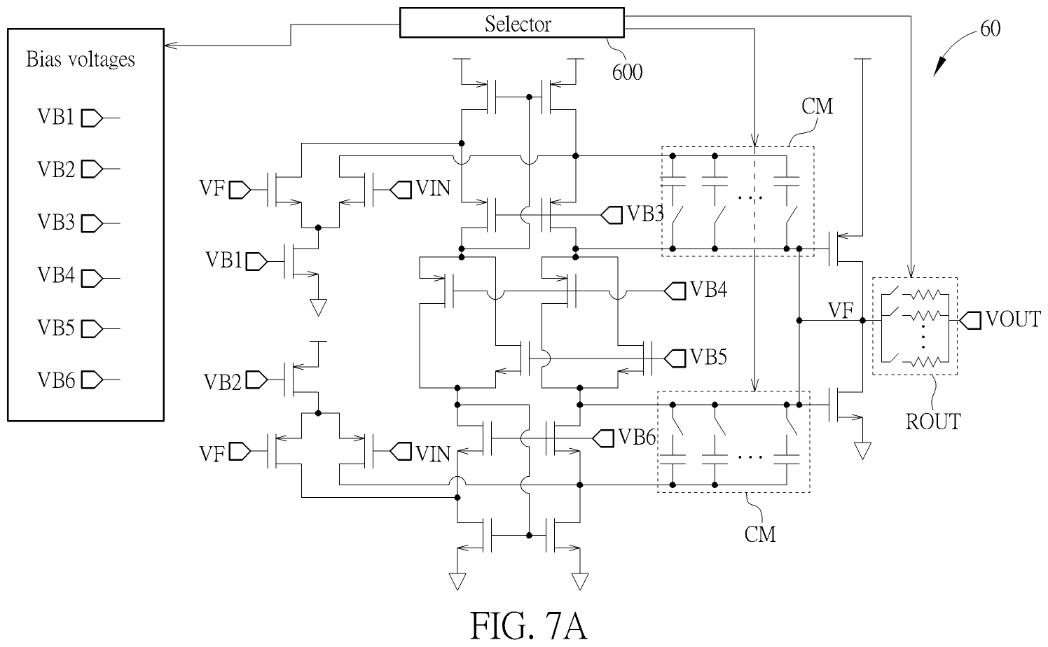

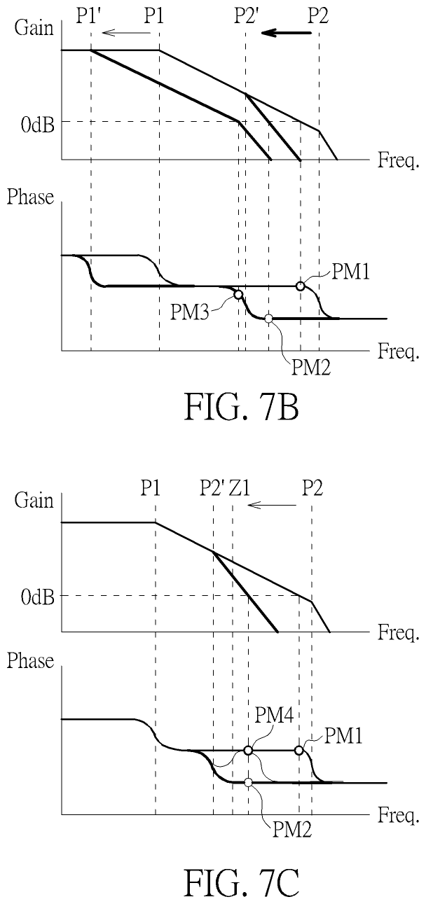

In order to improve the phase margin to solve the stability problem, the selection of power mode is performed together with the selection of compensation schemes. Please refer to FIG. 7A, which is a schematic diagram of the output driver 60 controlled by a selector 600, which has similar functions as the selector 206 shown in FIG. 2, where the selector 600 may select the configurations of the bias voltages VB1-VB6 with an adaptive lookup table control scheme based on the received display data. In addition, the selector 600 is further configured to select the arrangement of an array of compensation capacitors CM coupled between the feedback terminal (VF) and the gain stage and the arrangement of an array of output resistors ROUT coupled between the feedback terminal and the output terminal.

FIG. 7B illustrates a Bode plot corresponding to the output driver 60 with the compensation capacitors CM. As mentioned above, the decreased driving current IOUT will lead to a decreased secondary pole P2′ and a poor phase margin PM2. In such a situation, when the selector 600 selects the bias voltages VB1-VB6 that achieve a lower output driving capability and lower power consumption, the selector 600 may control more compensation capacitors CM in the capacitor array to be connected or enabled, so as to push the dominant pole P1 to a lower frequency level, i.e., P1′. As a result, the phase margin may return to a better level (from PM2 to PM3).

FIG. 7C illustrates a Bode plot corresponding to the output driver 60 with the output resistors ROUT. The output resistors ROUT may introduce a zero Z1 in the frequency response, where the zero Z1 may increase the phase margin. Therefore, when the selector 600 selects the bias voltages VB1-VB6 that achieve a lower output driving capability and lower power consumption, the selector 600 may control more output resistors ROUT in the resistor array to be connected or enabled, so as to push the zero Z1 to a lower frequency level, e.g., to be near the secondary pole P2′. As a result, the phase margin may return to a better level (from PM2 to PM4).

Therefore, with well control of the compensation capacitors CM, the output resistors ROUT, or both, the stability of the output driver will be improved by increasing the phase margin to a satisfactory level when the output driver operates in a low power mode having a lower driving current and lower power consumption.

Please note that the present invention aims at providing the bias voltage control for the output driver, so that the output driver is able to provide larger driving capability when the difference of the display data is larger and operate with less power consumption when the difference of the display data is smaller. Those skilled in the art may make modifications and alternations accordingly. For example, in the above embodiments, the selector is configured to perform controls of the bias voltages and arrangement of compensation capacitors and/or output resistors. In another embodiment, these circuit elements and parameters may be controlled by different selectors or controllers. Further, in addition to the difference of the input display data, the driving current of the output driver may also be determined based on the capacitive loading of the panel driven by the source driver. More specifically, a large-scale panel has a larger area and more pixels and thus always has larger parasitic capacitance on the data line; hence, higher driving capability may be required for the large-scale panel. In comparison, a low power mode of the output driver having a lower driving capability may be applicable to a small-scale panel with lower capacitive loading. In an embodiment, the adaptive bias voltage control of the present invention may be implemented with polarity inversion schemes.

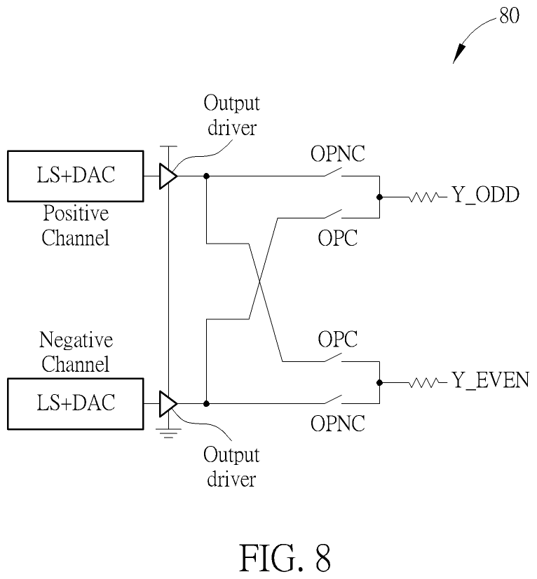

Please refer to FIG. 8, which is a schematic diagram of a source driver 80 with cooperation of two adjacent channels so as to achieve polarity inversion. As shown in FIG. 8, the source driver 80 includes a positive channel and a negative channel for outputting display data to the data lines Y_ODD and Y_EVEN on the panel. Each of the positive channel and the negative channel may output display data to one of the data lines Y_ODD and Y_EVEN with four output switches controlled by switching signals OPNC and OPC. The positive channel includes a level shifter, a DAC and an output driver, for dealing with display data with positive polarity. The negative channel also includes a level shifter, a DAC and an output driver, for dealing with display data with negative polarity. The switching signals OPNC and OPC control the display data with positive polarity and negative polarity to be forwarded to one of the data lines Y_ODD and Y_EVEN, so as to achieve a polarity inversion scheme such as the dot inversion or column inversion.

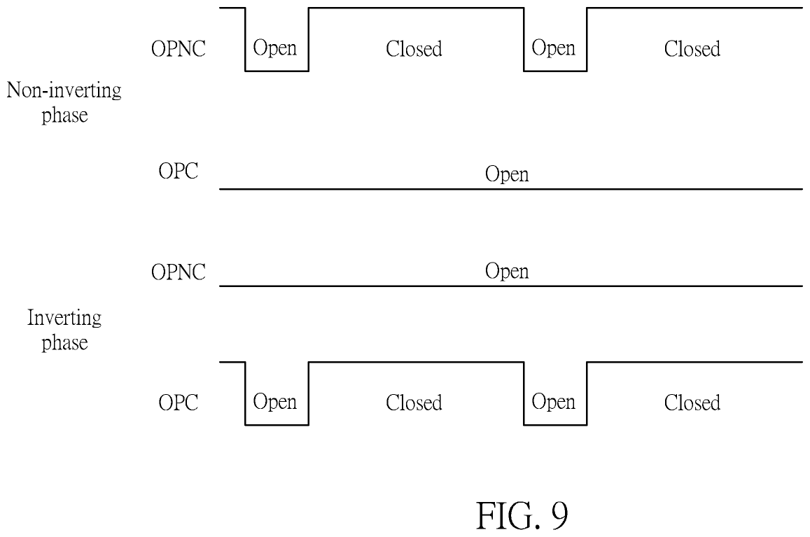

FIG. 9 illustrates a waveform diagram of the switching signals OPNC and OPC. In a non-inverting phase, the positive channel is configured to output display data to the data line Y_ODD and the negative channel is configured to output display data to the data line Y_EVEN; hence, the switching signal OPNC controls the corresponding output switches to be closed periodically, while the output switches controlled by the switching signal OPC are open. In an inverting phase, the positive channel is configured to output display data to the data line Y_EVEN and the negative channel is configured to output display data to the data line Y_ODD; hence, the switching signal OPC controls the corresponding output switches to be closed periodically, while the output switches controlled by the switching signal OPNC are open.

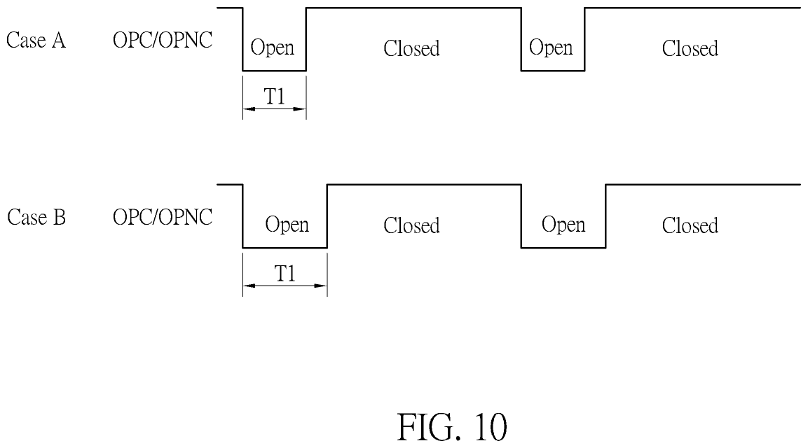

In an embodiment, the open time and the closed time of the output switches may be adjusted, in order to achieve an optimal performance of the settling time of the output data. Different bias voltage configurations of the output driver maybe implemented with different open time lengths T1 of the output switches, as shown in FIG. 10, no matter whether the source driver is in the non-inverting phase (with the control of OPNC) or the inverting phase (with the control of OPC). For example, the selector may further control the open time length T1 of the output switches based on the selections of bias voltages and the operation mode of the output driver. In detail, when the selector performs the bias voltage control which allows the output driver to operate in a low power mode, the output switches are preferably open for a longer time, i.e., be closed later, as Case B shown in FIG. 10. When the selector performs the bias voltage control which allows the output driver to operate in a high driving capability mode, the output switches are preferably open for a shorter time, i.e., be closed earlier, as Case A shown in FIG. 10.

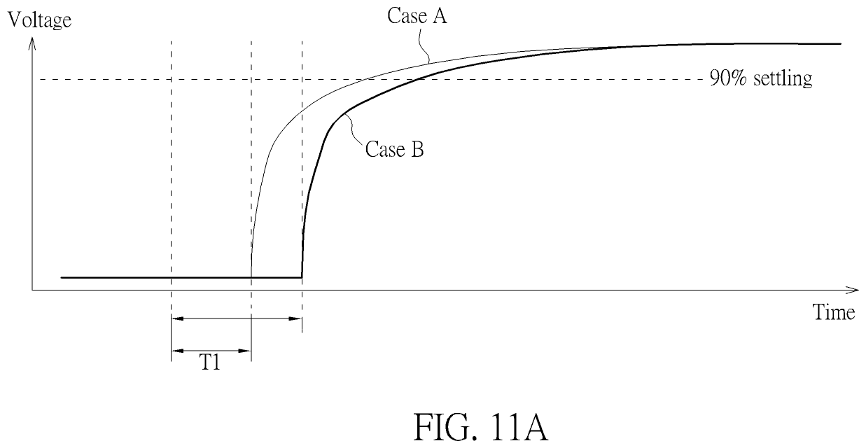

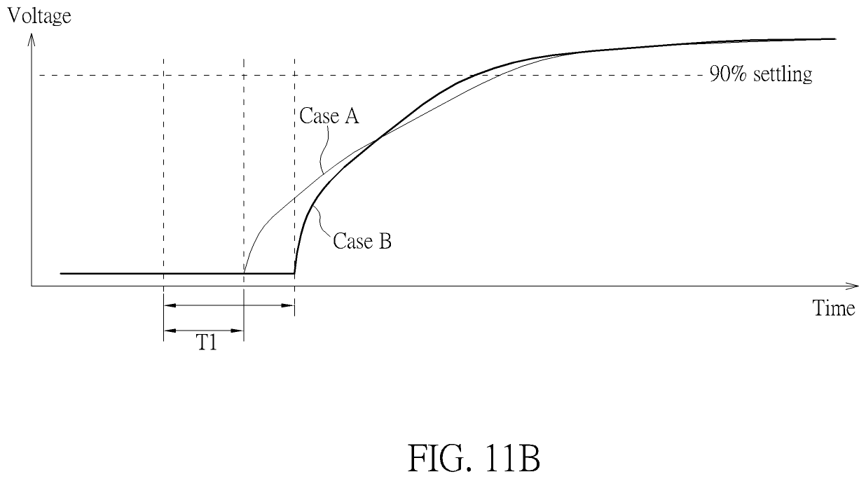

Please refer to FIGS. 11A and 11B, which are waveform diagrams of the output data of the output driver in different operation modes, where FIG. 11A illustrates the waveforms under the high driving capability mode of the output driver, and FIG. 11B illustrates the waveforms under the low power mode of the output driver. As shown in FIG. 11A, in the high driving capability mode, Case A with the shorter open time length T1 has a better settling time, as the output data in Case A reaches 90% earlier. This is because the output switches are closed earlier and thus the output data of the output driver is ready earlier if the driving capability is enough. In comparison, as shown in FIG. 11B, in the low power mode, Case B with the longer open time length T1 has a better settling time, as the output data in Case B reaches 90% earlier. This is because more time is required for the driving current of the output driver to charge its internal parasitic capacitance before the driving current can be used to charge the data line; hence, in Case A, the open time length T1 of the output switches is not enough for the driving current to charge the parasitic capacitance, such that the charging capability of the output driver and the rising time of the output data in Case A are much worse than those in Case B, which leads to a better settling time in Case B.

Please note that the loading of the panel may also influence the rising time of the output data of the output driver, and thereby influence the performance of settling time. The loading of the panel may vary in a wide range if the source driver is requested to be applicable to both the small-scale panel (e.g., a mobile phone) and the large-scale panel (e.g., a television). Therefore, the output control scheme of the source driver may be performed in consideration of both the operation mode of the output driver and the load magnitude of the panel, so as to achieve an optimal balance of the open time length of the output switches.

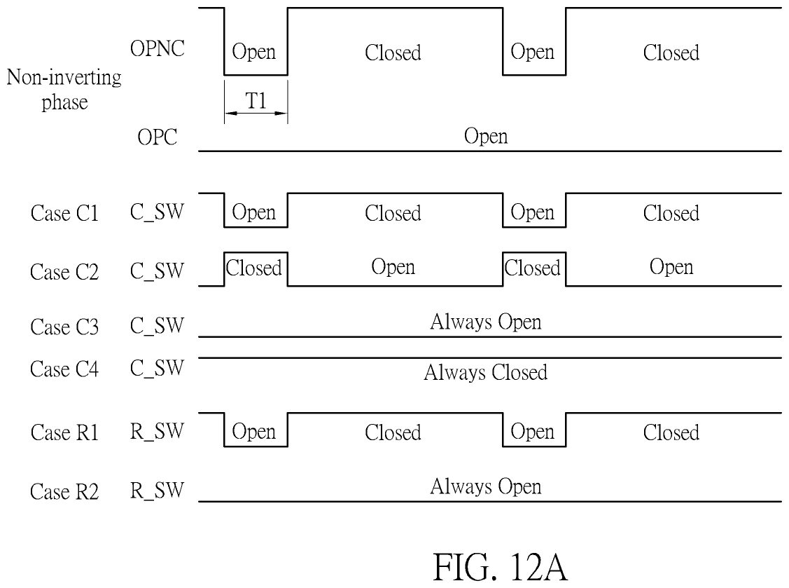

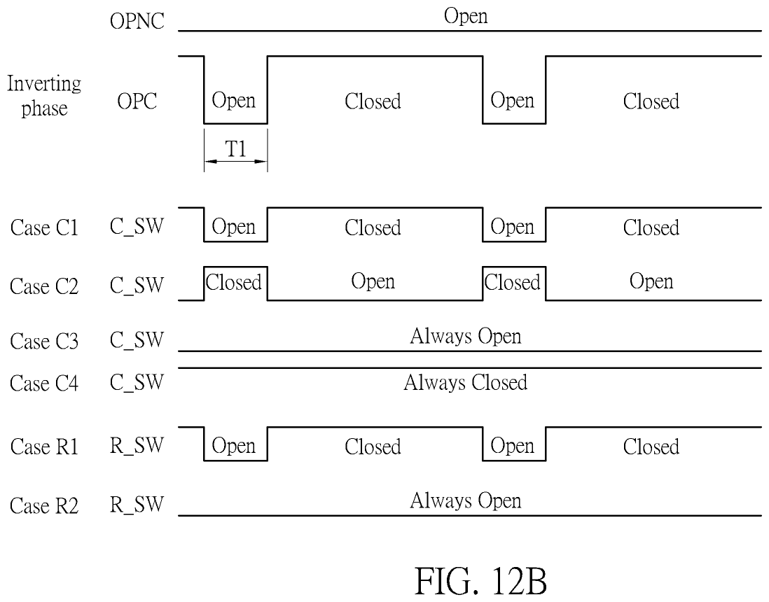

Please refer to FIGS. 12A and 12B, which are waveform diagrams of the switching signals OPNC and OPC and corresponding statuses of a capacitor switch C_SW and a resistor switch R_SW. The capacitor switch C_SW is configured to control a part of the compensation capacitors in the capacitor array as shown in FIG. 7A. The resistor switch R_SW is configured to control a part of the output resistors in the resistor array as shown in FIG. 7A. The capacitor switch C_SW and the resistor switch R_SW may be controlled in different ways to achieve better performance of the output driver such as lower power consumption and higher stability based on the statuses of the output switches. Accordingly, one of Cases C1 to C4 and one of Cases R1 and R2 may be selected to achieve better performance. Take the non-inverting phase as an example, where the switching signal OPNC operates while the switching signal OPC is always open, as shown in FIG. 12A. For a general small-scale panel, Case C1 may be selected, where the capacitor switch C_SW is open when the output switches are open and the capacitor switch C_SW is closed when the output switches are closed. For a general large-scale panel, Case C2 may be selected, where the capacitor switch C_SW is open when the output switches are closed and the capacitor switch C_SW is closed when the output switches are open. FIG. 12B illustrates the inverting phase, where the operations of the capacitor switch C_SW and the resistor switch R_SW are similar to those shown above, and will be omitted herein.

To sum up, the present invention provides a source driver having a selector capable of selecting bias voltages for an output driver based on the input display data. With a larger difference between two adjacent input display data, the output driver is required to operate in a high driving capability mode. With a smaller difference between two adjacent input display data, the output driver is able to operate in a low power mode. The selector may select appropriate bias voltages from one of a plurality of bias voltage generators, so as to achieve the high driving capability or low power consumption. Due to a lower driving current in the low power mode, the phase margin may become worse; hence, adaptive arrangements of compensation capacitors and output resistors are applied to raise the phase margin to a satisfactory level. In addition, the open time length of the output switches of the output driver may be adjusted or controlled in consideration of the output driving capability of the output driver and the load magnitude of the panel. The arrangements of the compensation capacitors and output resistors may also be configured accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A source driver for a panel, the source driver comprising a plurality of driver cells, each of the driver cells comprising:
an output driver, configured to output a plurality of display data to the panel;
a plurality of bias voltage generators, coupled to the output driver, each of the bias voltage generators configured to provide at least one bias voltage for the output driver; and
a selector, coupled to the output driver, configured to select the bias voltage from one of the bias voltage generators to be provided for the output driver according to the plurality of display data.

2. The source driver of claim 1, wherein the selector is configured to select the bias voltage from one of the bias voltage generators according to a difference between two display data among the plurality of display data.

3. The source driver of claim 1, wherein the selector is configured to select the bias voltage from one of the bias voltage generators further according to a capacitive loading of the panel.

4. The source driver of claim 1, wherein each of the driver cells further comprises:
a first latch and a second latch, configured to store the plurality of display data;
wherein when a first display data among the plurality of display data is stored in the first latch and a second display data among the plurality of display data is stored in the second latch, the selector receives the first display data from the first latch and receives the second display data from the second latch, and selects the bias voltage from one of the bias voltage generators according to a difference between the first display data and the second display data.

5. The source driver of claim 4, wherein the selector comprises:
a controller, configured to receive the first display data from the first latch and receive the second display data from the second latch, and generate a control signal according to the difference between the first display data and the second display data; and
a multiplexer, coupled to the controller, configured to select one of the bias voltage generators to be coupled to the output driver according to the control signal from the controller.

6. The source driver of claim 1, wherein the selector is further configured to select an arrangement of capacitors for the output driver according to the plurality of display data.

7. The source driver of claim 1, wherein the selector is further configured to select an arrangement of resistors for the output driver according to the plurality of display data.

8. The source driver of claim 1, wherein a bias voltage control for the output driver of each of the driver cells is independent from the bias voltage control for the output driver of other driver cells among the plurality of driver cells.

9. The source driver of claim 1, wherein the selector is further configured to control an open time length of an output switch of the output driver.

10. The source driver of claim 9, wherein the open time length is determined according to an operation mode of the output driver and a load magnitude of the panel.

11. The source driver of claim 1, wherein the output driver is an operational amplifier.

12. A selector for a source driver, for controlling at least one bias voltage provided for an output driver of the source driver, the selector comprising:
a controller, configured to receive a first display data and a second display data of the source driver, and generate a control signal according to a difference between the first display data and the second display data; and
a multiplexer, coupled to the controller, configured to select one of a plurality of bias voltage generators to be coupled to the output driver according to the control signal from the controller.

13. The selector of claim 12, wherein the multiplexer is configured to select one of the plurality of bias voltage generators to be coupled to the output driver further according to a capacitive loading of a panel driven by the source driver.

14. The selector of claim 12, wherein the source driver further comprises:
a first latch and a second latch, configured to store the first display data and the second display data;
wherein when the first display data is stored in the first latch and the second display data is stored in the second latch, the selector receives the first display data from the first latch and receives the second display data from the second latch, and selects the bias voltage from one of the bias voltage generators according to the difference between the first display data and the second display data.

15. The selector of claim 12, wherein the selector is further configured to select an arrangement of capacitors for the output driver according to the difference between the first display data and the second display data.

16. The selector of claim 12, wherein the selector is further configured to select an arrangement of resistors for the output driver according to the difference between the first display data and the second display data.

17. The selector of claim 12, wherein a bias voltage control for the output driver of a driver cell of the source driver is independent from the bias voltage control for an output driver of another driver cell of the source driver.

18. The selector of claim 12, wherein the selector is further configured to control an open time length of an output switch of the output driver.

19. The selector of claim 18, wherein the open time length is determined according to an operation mode of the output driver and a load magnitude of a panel driven by the source driver.

20. The selector of claim 12, wherein the output driver is an operational amplifier.
